(19) United States
(12) Patent Application Publication
(10) Pub. No.: US 2006/0289683 A1
(43) Pub. Date: Dec. 28, 2006

(54) Dispenser

(75) Inventors: Lars Olsson, Tyreso (SE); Christer Ohlin, Varmdo (SE)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL COATINGS INTERNATIONAL B.V., Arnhem (NL)

(21) Appl. No.: 11/473,954

(22) Filed: Jun. 23, 2006

Related U.S. Application Data
(60) Provisional application No. 60/693,080, filed on Jun. 23, 2005.

(51) Int. Cl. B05B 1/14

(52) U.S. Cl. 239/565

(57) ABSTRACT

An apparatus arranged for dispensing a liquid, said apparatus comprising a cavity having an inlet connectable to a liquid source operable for supplying liquid under pressure to the cavity, and a number of outlets through which the liquid is discharged to a substrate which is provided below the apparatus in order to receive the liquid, each outlet is individually communicating with the cavity through separate passages that connect individually to the top of the cavity.

This application claims priority based on U.S. Provisional Patent Application No. 60/693,080, filed Jun. 23, 2005.

The present invention relates to an apparatus designed for dispensing a liquid such as an adhesive system onto a substrate.

### BACKGROUND

The dispensers referred to are frequently used in applications wherein a liquid, such as an adhesive or other liquid component included in an adhesive system, such as a resin component and a hardener component, is discharged to a surface of a piece of material that is successively combined with other such pieces in a laminated structure, such as a wood laminate. In the wood lamination industry, pieces of wood are typically conveyed below a dispenser by which the adhesive is distributed to the wood pieces in the form of curtains or parallel strings. Basically, liquid is supplied under pressure to a cavity in the dispenser from which the liquid is discharged through a multiplicity of outlets or nozzles arranged in one or several rows on the lower side of the dispenser. The dispensers are typically oriented horizontally and transversely to the general direction of a relative movement between dispenser and substrate.

A frequently occurring problem in this connection is the accumulation of gas bubbles in the dispenser, forming pockets of gas in the dispenser cavity. The gas, which may originate from structural components building up the supplying system, such as stirrers, pumps, connectors etc. drawing air into the liquid, or from chemical processes in the liquid, disadvantageously affects the discharge of liquid through the outlets. Specifically, the occurrence of gas pockets may cause an uneven distribution of liquid through the outlets, resulting in uneven and unsatisfactory bonding between the wood pieces. The accumulation of gas bubbles in the dispenser is further supported when the inner structure of the dispenser gives rise to stagnant or trapped volumes of liquid.

A non-homogenous distribution of liquid over the line of outlets is also believed to originate from a successively falling internal pressure in the liquid filling the dispenser cavity from an inlet end to the remote end. This shortcoming is further expressed when the pressure drop over the outlets is low, resulting in a heavier flow through an outlet close to the inlet than through the next outlet in the row.

### SUMMARY OF THE INVENTION

The present invention aims to solve the problem discussed above and avoids the formation of gas pockets within the apparatus. This object is met in a liquid dispensing apparatus comprising a cavity having an inlet connectable to a liquid source operable for supplying liquid under pressure to the cavity, and a number of outlets through which the liquid is dispensable to a substrate, wherein each outlet individually communicates with the cavity through separate passages mouthing in the cavity, wherein each passage mouths in the cavity through a separate exit, each said exit intersecting adjacent exits arranged in a top of the cavity.

Briefly, an apparatus is arranged for dispensing a liquid, comprising a cavity having an inlet connectable to a liquid source operable for supplying liquid under pressure to the cavity, and a number of outlets through which the liquid is discharged to a substrate which is provided below the apparatus in order to receive the liquid. According to the present invention, each outlet individually communicates with the cavity through separate passages, each said passage connecting individually to the top of the cavity.

The liquid referred to is suitably an adhesive, or other liquid component included In an adhesive system such as a resin component and a hardener component.

Preferably, each outlet communicates with a separate exit, each said exit intersecting with adjacent exits arranged in the top of the cavity.

Advantageously, the exits are formed in a lower side of a spreader insert which is mountable to cover an open top of the cavity.

The spreader insert preferably is formed with multiple through holes, each through hole mouthing in a recess formed in the lower side of the spreader insert, each said recess transforming into adjacent recesses through an intersection line.

In an advantageous realization of the spreader insert, the recesses are formed as inverted cones, or inverted spheres, or inverted pyramids having three or more sides.

In effect of exiting the liquid from the top of the cavity, each outlet is connectable to an appurtenant exit via an interconnecting passage that is formed to turn the flow direction towards the outlets.

Advantageously, the passage is arranged to turn the liquid flow through 180 degrees from the exit to the outlet.

In one embodiment the passage is arranged initially to direct the liquid flow upwards upon exit from the cavity.

In alternative embodiments, each outlet is connectable to an appurtenant exit via interconnecting conduits formed to turn the flow direction towards the outlets.

The apparatus general structure comprises:
a main block formed with a cavity and multiple outlets;
a spreader insert receivable at the open top of the cavity, the spreader insert having multiple exits;
a cover block mountable over the main block and the spreader insert, the cover block interconnecting the exits and the outlets for fluid communication, and
snap lock means for mounting and dismounting the cover block from the main block.

The present invention further includes the use of the apparatus according to the present invention for applying a liquid onto a substrate. The liquid is preferably an adhesive, or other liquid component included in an adhesive system such as a resin component and a hardener component. The substrate is preferably a wood based substrate.

The dispenser of the present invention will be more closely described below with reference to the accompanying drawings, wherein

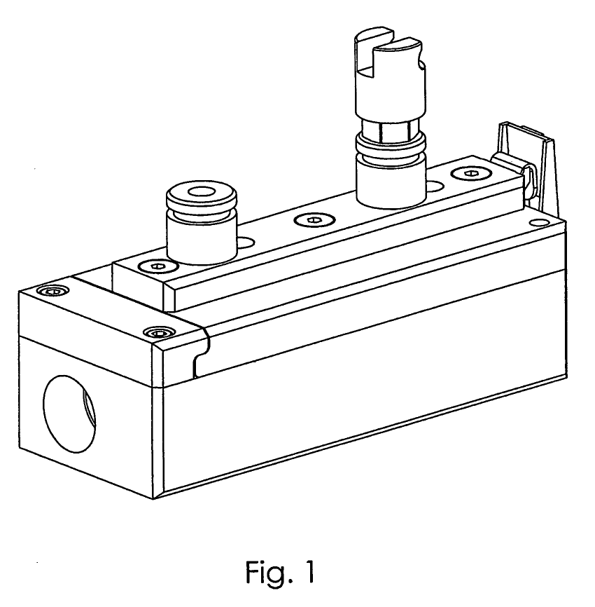

FIG. 1 is a perspective view showing the dispenser of the present invention from above;

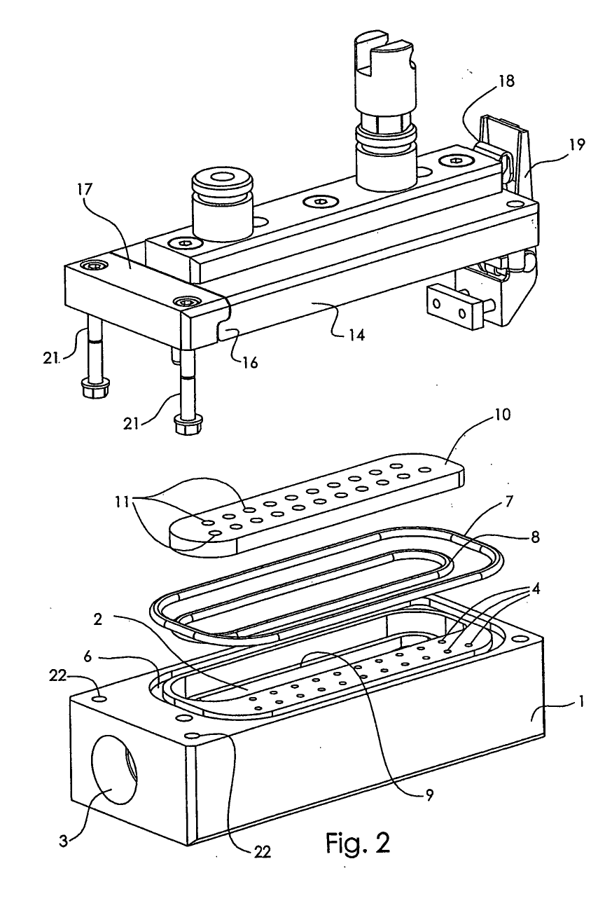

FIG. 2 is an exploded top view showing the structural details of the dispenser;

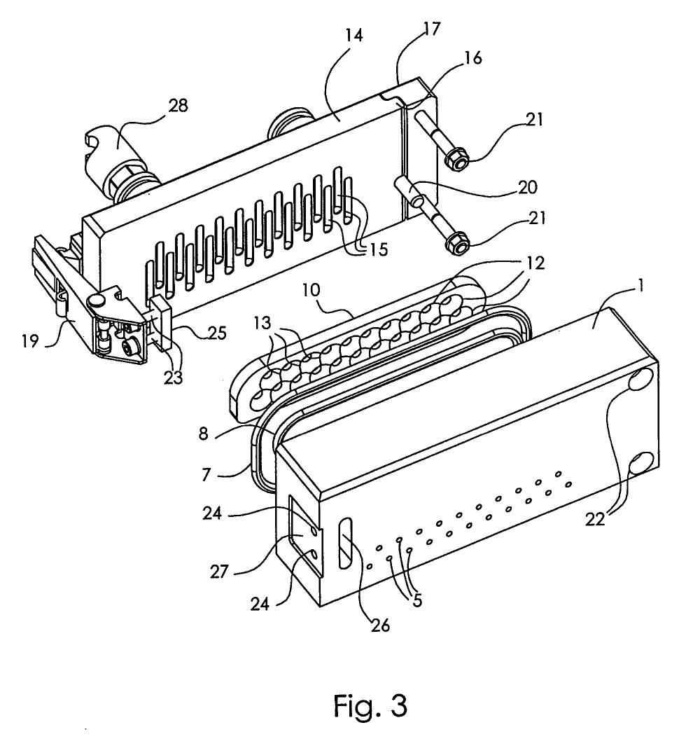

FIG. 3 is an exploded bottom view showing the same;

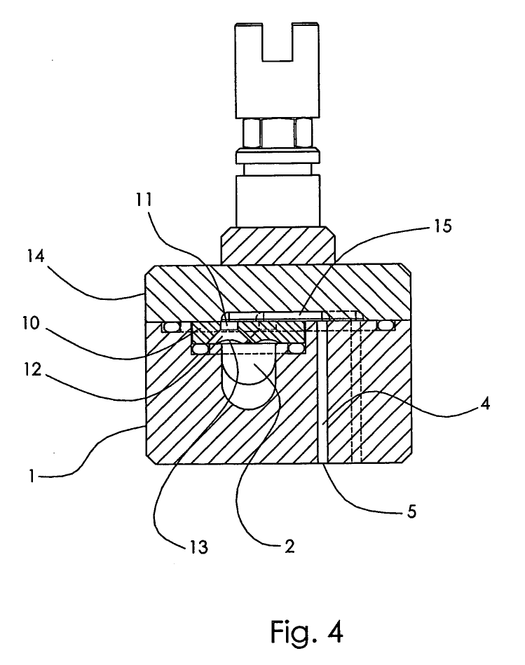

FIG. 4 is a transversal section through the dispenser, and

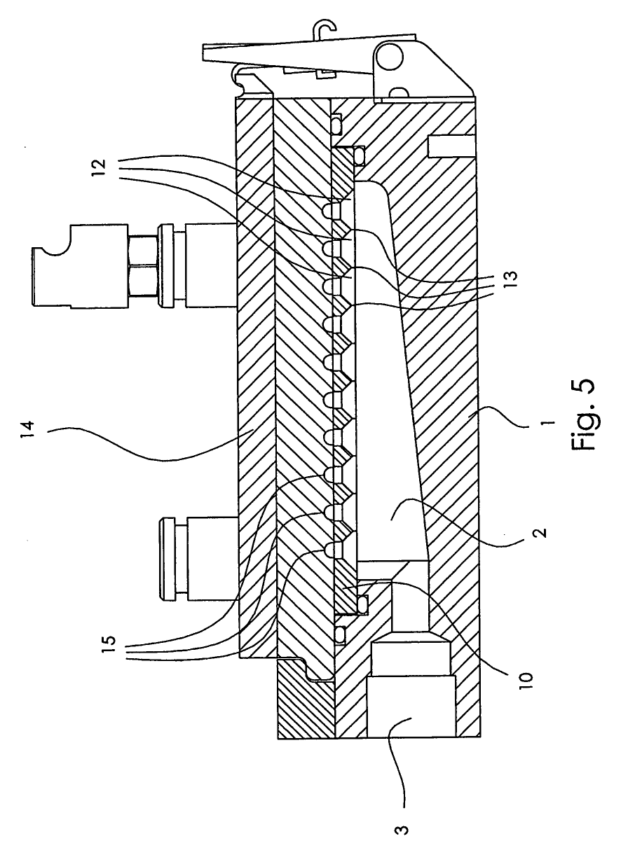

FIG. 5 is a longitudinal section through the same.

### DETAILED DESCRIPTION OF THE INVENTION

One embodiment of the dispensing apparatus according to this invention is shown in the drawings, from which it is readily apparent that the present dispenser is dismountable for maintenance. Typically, the dispensers referred to are elongate bodies, having a longitudinal dimension adapted for dispensing the liquid over the total width of a substrate that is provided below the dispenser. Nevertheless, multiple dispensers may in some applications be required to fully cover the width of a substrate.

With reference to the drawings, the dispenser comprises a main block 1, forming a base onto which the other details of the dispenser are attachable. The main block 1 has an elongate cavity 2 extended in the longitudinal direction of the main block. The cavity 2 opens in the top side of the main block 1, and is supplied with liquid via an inlet 3 which opens in a side surface of the main block. Though not shown in the drawings, the inlet 3 is connectable to a liquid source via pumping means which are operable to feed the liquid under pressure to the cavity 2. Advantageously, the sectional area of the cavity 2 may be reducing from an inlet end towards an opposite end of the cavity, preferably realized through a successively reducing depth or width in this direction of the cavity. A plurality of through holes or passages 4 connect the top side of the main block 1 with the lower side thereof, the passages 4 mouthing in the lower side in one or several rows of individual outlets 5 as is visible from FIG. 3. The outlets may conventionally be adapted to receive separate nozzles, if appropriate. A groove 6 is formed to receive a sealing member 7, continuously encircling the cavity and passage openings in the top side of main block 1. An additional sealing member 8 is receivable to rest on a shoulder 9 which runs continuously about an inner wall of the cavity 2, and which shoulder provides a seat for a spreader insert 10.

The spreader insert 10 forms a top cover for the cavity 2, and is receivable to rest on the shoulder 9 and sealing member 8 with its top surface leveling with the top surface of the main block 1. A number of through holes or passages 11 are formed through the spreader insert 10, equaling the number of passages 4 passing through the main block 1. Each passage 11 mouths in the lower surface of the spreader insert 10 through a widened opening 12, visible in FIGS. 3-5. These openings 12, constituting the exit from the cavity, may be formed as conical or spherical cups, or inverted pyramids having three or more sides, recessed from the lower surface of the spreader insert. Advantageously, the recesses or exits 12 are dimensioned to overlap adjacent exits such that each exit 12 transforms into an adjacent exit 12 via an intermediate intersection line 13, i.e. each exit intersects with adjacent exits without any substantial interconnecting surface between adjacent exits 12, as is notable from the drawings. On the top side of the spreader insert 10, the passages 11 mouth in a pattern that allows each passage 11 to be aligned with the top side opening of a an appurtenant passage 4 through the main block 1.

The passage 11 may be formed with a more or less accentuated vertical length measured from the upper end of the corresponding exit 12 to the top side of the spreader insert 10. One embodiment of the present invention foresees that the flow of liquid is initially directed upwards through a vertical length of the passage 11, upon exit from the cavity, and turned twice through a total of 180 degrees before discharge via the outlets.

A cover block 14 is arranged for connecting each passage 11 through the spreader Insert 10 with a corresponding passage 4 through the main block 1. For this purpose, the cover block 14 is formed in its lower surface with a number of grooves 15, the lengths of which are adapted for connecting a top side mouth of a passage 11 with the appurtenant top side mouth of a passage 4. In its mounted position, the grooves 15 in the cover block complete the individual fluid passages from the exits 12 to the outlets 5.

The cover block 14 is readily mountable and dismountable, respectively, on the main block 1 through a snap connection. In one end, the cover block has a heel 16 which is shaped to engage the lower side of a corresponding nose 17 arranged on the main block. The opposite end of the cover block is formed with a lug 18 which is arranged for engagement with an eccentric lock mechanism 19. In a snapped on position, the lower surface of the cover block is sealingly pressed towards the top surfaces of the main block 1 and the spreader insert 10, respectively. A centering pin 20, threaded through the cover block, ensures the correct positioning and free passageways from the cavity's exits to the outlets, via passage sections 11, 15, and 4.

For a full presentation of the illustrated embodiment, the nose 17 is bolted to the main block through a couple of screws 21 reaching through bores 22 formed in the main block. The eccentric lock mechanism 19 is bolted to the main block through a couple of screws 23, reaching through bores 24 and engaging an anchor 25 inserted in a slot 26 which runs parallel to a seat 27 for the eccentric lock mechanism, the seat 27 being formed in a side surface of the main block 1. On its top side, the cover block comprises means 28 adapted for installing the dispenser in a production line.

As apparent from the above description of the structural design, the liquid passage through the dispenser from the inlet 3 to the outlets 5 contains no obstructing or entrapping formations where gas bubbles may accumulate, or formations that may prevent any gas bubbles present in the liquid from being transported with the liquid flow through the passages. Moreover, the exits from the cavity are oriented in the top of the cavity, taking advantage of the natural rise of lighter gas bubbles eventually enclosed in the liquid. Furthermore, any gas bubble that rises through liquid standing in the cavity during intermittent operation is instantaneously introduced in a partial flow and captured in a flow of comparatively high velocity through the passages, directing the flow from the cavity to the outlets. The capacity to vent the dispenser apparatus is further enhanced by arranging separate passages initially to direct the liquid flow so as to exit from the top of the cavity, and successively to turn the partial flows towards the outlets.

In effect of exiting the liquid from the top of the cavity, the flow direction must be altered through 90 or 180 degrees in order to discharge the liquid from the lower side of the dispenser. The inevitable horizontal and vertical components of this multidirectional liquid flow results in added passage length from exit to outlet, generating a corresponding resistance and pressure drop over the passages. The raised drop in pressure over the passages advantageously reduces the influence of a falling pressure internally in the cavity, thus also reducing or avoiding a non-homogenous distribution of liquid over the line of outlets.

Another advantage achieved by the presented dispenser is a continuous and complete liquid turnover in the cavity, resulting in part from the non-broken exit area facing the cavity from above, and in part from the reducing sectional area from the inlet towards the remote end of the cavity. In effect thereof the structure avoids stagnant volumes of liquid, and accordingly avoids the risk of entrapped volumes of liquid impairing the distribution of liquid as well as the risk of entrapped volumes of adhesive curing in the cavity.

The invention is illustrated with respect to an embodiment to which modifications are possible without departing from the basic solution. For example, instead of passageways that are machined as channels through block elements, the outlets 5 may be individually connectable with the exits from the cavity through separate conduits connecting to a distributor covering the top of the cavity.

1. An apparatus arranged for dispensing a liquid, the apparatus comprising:
a cavity having an inlet connectable to a liquid source from which liquid under pressure can be supplied to the cavity;
a number of outlets from which liquid supplied to the cavity is dispensable towards a substrate;
each said outlet communicating individually with the cavity through separate passages, wherein
each said passage mouths in the cavity through a separate exit, each one of said exits intersecting adjacent exits from the top of cavity.

2. The apparatus of claim 1, wherein said exits from the cavity transform into adjacent exits through lines of intersection.

3. The apparatus of claim 2, wherein said exits from the cavity are recesses formed as one of inverted cones, inverted spheres and inverted pyramids having three or more sides.

4. The apparatus of claim 3, wherein said exits from the cavity are formed in a lower side of a spreader insert which is mountable to cover an open side of the cavity.

5. The apparatus of claim 4, wherein said open side of the cavity covered by the insert is a top side.

6. The apparatus of claim 5, wherein each passage directs the liquid flow through 180° from the cavity to the associated outlet.

7. The apparatus of claim 1, wherein each outlet is connectable to an associated exit via an interconnecting conduit formed to turn the flow direction towards the outlets.

8. The apparatus of claim 1, connected to a liquid source supplying at least one of adhesive and component of an adhesive system for dispensing through the outlets.

9. An apparatus arranged for dispensing liquid, comprising
a main block formed with a cavity having an inlet connectable to a liquid source from which liquid under pressure can be supplied to the cavity, said cavity opening in a top side of the main block;
multiple passages through the main block connecting individually the top side of the main block with multiple outlets mouthing in a lower side of the main block;
a separate insert element covering the open top of the cavity, said insert having multiple passages there-through connecting lower and upper sides of the insert;
a cover block holding the insert to the main block, the cover block having multiple passages formed therein connecting each outlet individually with the cavity for fluid communication, by the passages of said cover block interconnecting said passages through the main block individually to corresponding passages through the insert.

10. The apparatus of claim 9, wherein each passage through the insert mouths in the lower side thereof through a separate exit, each said exit intersecting adjacent exits in the lower side of the insert.

11. The apparatus of claim 9, wherein each passage through the insert mouths in the lower side thereof through a separate exit, each said exit transforming into adjacent exits through lines of intersection.

12. The apparatus of claim 11, wherein said exits are recesses formed as one of inverted cones, inverted spheres and inverted pyramids having three or more sides.

13. The apparatus of claim 9, wherein the cover block is connectable to the main block through snap lock means.

14. The apparatus of claim 9, connected to a liquid source supplying at least one of adhesive and component of an adhesive system for dispensing through the outlets.

15. An apparatus arranged for dispensing liquid, comprising
a main block formed with a cavity having an inlet connectable to a liquid source from which liquid under pressure can be supplied to the cavity, said cavity opening in a top side of the main block;
multiple passages through the main block connecting individually the top side of the main block with multiple outlets mouthing in a lower side of the main block;
a separate insert element covering the open top of the cavity, said insert having multiple passages there-through connecting lower and upper sides of the insert;
a cover block holding the insert to the main block, the cover block having multiple passages formed therein connecting each outlet individually with the cavity for fluid communication, by the passages of said cover block interconnecting said passages through the main block individually to corresponding passages through the insert, wherein liquid flow through each said passage is turned through 180° from the cavity to the outlets.

16. The apparatus of claim 15, wherein each passage through the insert mouths in the lower side thereof through a separate exit, each said exit intersecting adjacent exits in the lower side of the insert.

17. The apparatus of claim 15, wherein each passage through the insert mouths in the lower side thereof through a separate exit, each said exit transforming into adjacent exits through lines of intersection.

18. The apparatus of claim 17, wherein said exits are recesses formed as one of inverted cones, inverted spheres and inverted pyramids having three or more sides.

19. The apparatus of claim 15, wherein the cover block is connectable to the main block through snap lock means.

20. The apparatus of claim 15, connected to a liquid source supplying at least one of adhesive and component of an adhesive system for dispensing through the outlets.
